(19) United States
(12) Patent Application Publication
(10) Pub. No.: US 2019/0260150 A1
(43) Pub. Date: Aug. 22, 2019

(54) ELECTRICAL POWER CONNECTOR ASSEMBLY

(71) Applicant: TE CONNECTIVITY CORPORATION, Berwyn, PA (US)

(72) Inventor: Brian Patrick Costello, Scotts Valley, CA (US)

(21) Appl. No.: 15/898,685

(22) Filed: Feb. 19, 2018

(51) Int. Cl. H01R 13/44; H01R 13/187; H01R 13/506; H01R 13/629

(52) U.S. Cl. CPC H01R 13/44; H01R 13/62938; H01R 13/506; H01R 13/187

(57) ABSTRACT

An electrical power connector assembly includes a plug module having a plug carrier with a plug mating end, a plug cable end and a plug channel extending therebetween, a plug contact received within the plug channel, and a plug cable connected to the plug contact. The assembly includes a receptacle module having a receptacle carrier with a receptacle mating end, a receptacle cable end and a receptacle channel extending therebetween, a receptacle contact received within the receptacle channel and being matable and unmatable with the plug contact, and a receptacle cable connected to the receptacle contact. The assembly includes a safety mechanism received within the plug channel configured to move within the plug channel between an unmated position wherein the plug contact is isolated from electrical contact from the receptacle contact and a mated position that provides for mating between the plug contact and the receptacle contact.

### BACKGROUND OF THE INVENTION

The subject matter herein relates generally to an electrical connector, and more particularly, to an electrical power connector assembly with a safety mechanism.

Electrical connector assemblies are utilized in a variety of applications and fields. For example, electrical connector assemblies may be used in the fields of telecommunications, data storage, internet applications, personal computers, and the like. In additional, electrical connector assemblies may be used for applications, such as, connecting components, boards and cards in computers, power systems, data centers, servers, networks and the like. In some applications, electrical connector assemblies include a plug module mateable with a receptacle module, each which may be mounted to some form of support structure. As an example, one of the plug or receptacle modules may be connected to a cable harness, subassembly, component, card, panel or circuit board, while the other module may be mounted to a bulkhead, rack assembly, or other structure that holds the card, panel, board, component or subassembly. The electrical connectors used in interconnecting rack and panel assemblies may be referred to as “drawer connectors.”

Electrical connector assemblies allow users of electronic equipment to transfer electrical power between power sources and/or electrical devices. Increasingly, connector assemblies include greater numbers of electrical contacts and transmit greater amounts of power. As a result, the connector assemblies are more difficult to mate, and the amount of power communicated through the connector assemblies may be large enough to pose a safety risk. For example, any conductive objects, such as tools, equipment, that comes in contact with any exposed and/or accessible portion of the contacts can be damaged and any personnel that come in contact with any exposed and/or accessible portion of the contacts cab be severely hurt or killed. Therefore, installation and operation of the connector assemblies must be limited to trained personnel.

Therefore, there is a need for an electrical power connector assembly that can be safely and reliably mated and unmated by untrained personnel for the communication of electrical power between electrical devices.

### BRIEF DESCRIPTION OF THE INVENTION

In one embodiment, an electrical connector assembly is provided that includes a plug module having a plug carrier with a plug mating end, a plug cable end opposite the plug mating end, and one or more plug channels extending therebetween. One or more plug contacts are received within the one or more plug channels, and one or more plug cables are electrically connected to the one or more plug contacts. A receptacle module includes a receptacle carrier with a receptacle mating end, a receptacle cable end and one or more receptacle channels extending therebetween. One or more receptacle contacts are received within the one or more receptacle channels being matable with and unmatable with the plug contacts, and one or more receptacle cables electrically connected to the one or more receptacle contacts proximate the receptacle cable end. The electrical connector assembly also includes a safety mechanism received within the one or more plug channels and is configured to move within the one or more plug channels between an unmated position wherein the one or more plug contacts are isolated from electrical contact from the one or more receptacle contacts and a mated position that provides for mating between the plug contacts and the receptacle contacts.

In another embodiment, an electrical connector assembly is provided that includes a receptacle module having a receptacle carrier with a receptacle mating end, a receptacle cable end and at least one receptacle channel extending therebetween. At least one receptacle contact is received within at least one receptacle channel, and at least one receptacle cable electrically is connected to the at least one receptacle contact proximate the receptacle cable end. The electrical connector assembly also includes a plug module having a plug carrier with a plug mating end, a plug cable end, and a plug channel extending therebetween. At least one plug contact is received within the at least one plug channel and has a conductive surface extending along a central longitudinal axis being configured to mate and unmate with the at least one receptacle contact. At least one plug cable is electrically connected to the at least one plug contact and at least one insulative plunger is configured to move along the central longitudinal axis of the plug contact between an unmated position wherein the conductive surface is isolated from electrical contact with the receptacle contact and a mated position that provides for mating between the conductive surface of the plug contact and the receptacle contact.

In a further embodiment, an electrical connector assembly is provided that includes a plug module configured for mating and unmating with a receptacle module, the plug module having a plug carrier with a plug mating end, a plug cable end, and a plug channel extending therebetween. At least one plug contact is received within the at least one plug channel and has a conductive surface extending along a central longitudinal axis being configured to mate and unmate with the receptacle module. At least one plug cable is electrically connected to the at least one plug contact, at least one insulative plunger is configured to move along the central longitudinal axis of the plug contact between an unmated position wherein the conductive surface is isolated from electrical contact with the receptacle module and a mated position that provides for mating between the conductive surface of the plug contact and the receptacle module.

### BRIEF DESCRIPTION OF THE DRAWINGS

FIG. 1 illustrates a front perspective view of an electrical connector assembly in an unmated position accordance with an embodiment.

FIG. 2 illustrates a rear perspective view of the electrical connector assembly in the unmated position in accordance with an embodiment.

FIG. 3 is a front partially exploded perspective view of a receptacle module in accordance with an embodiment.

FIG. 4 is a rear partially exploded perspective view of the receptacle module in accordance with an embodiment.

FIG. 5 is a rear partially exploded perspective view of the plug module in accordance with an embodiment.

FIG. 6 is an exploded perspective view of the plug module and a safety mechanism in accordance with an embodiment.

FIG. 7 is a cross-sectional view of the electrical connector assembly with the receptacle module and the plug module in the unmated position according to an embodiment.

FIG. 8 is a cross-sectional view of the electrical connector assembly with the receptacle module and the plug module in an impending mating position according to an embodiment.

FIG. 9 is a cross-sectional view of the electrical connector assembly with the receptacle module and the plug module in the mated position according to an embodiment.

FIG. 10 is a front exploded perspective view of the receptacle module with an adaptor according to an embodiment.

FIG. 11 is a rear partially exploded view of the receptacle module with the adaptor and cable according to an embodiment.

FIG. 12 is a perspective view of the electrical connector assembly in the unmated position with a latch assembly in a secured position and keying features.

FIG. 13 is a side view of the electrical connector assembly in the mated position with the latch assembly in the unsecured position according to an embodiment.

FIG. 14 is a perspective view of the electrical connector assembly with an alternate latch assembly according to an embodiment.

FIG. 15 is a partially exploded perspective view of the plug module with a pre-mate connector according to an embodiment.

FIG. 16 is a cross-section view of the electrical assembly with the pre-mate connector in the unmated position.

FIG. 17 is an enlarged cross-section view of sacrificial contacts of the pre-mate connector in the mating position.

### DETAILED DESCRIPTION OF THE INVENTION

Embodiments described herein include an electrical power connector assembly having a plug module and a receptacle module configured to mate and unmate for the communication of electrical power between electrical devices, which may have a variety of configurations as set forth herein.

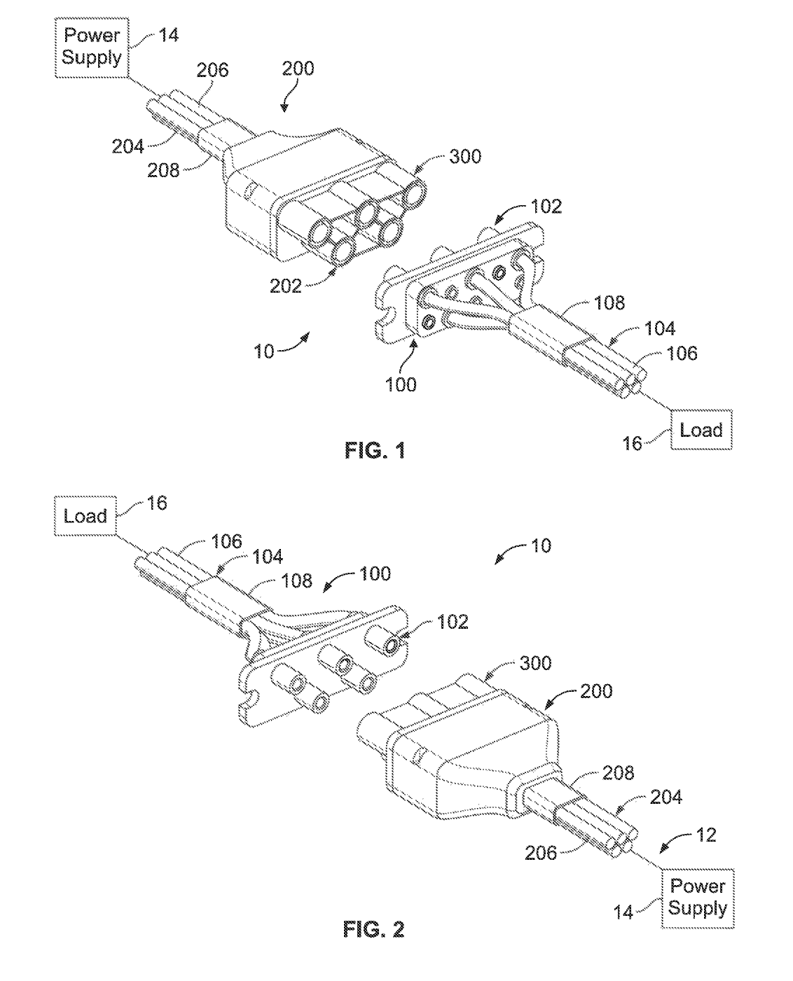

FIG. 1 illustrates a front perspective view of an electrical connector assembly 10 in an unmated position accordance with an embodiment. FIG. 2 illustrates a rear perspective view of the electrical connector assembly 10 in the unmated position in accordance with an embodiment. The electrical connector assembly 10 includes a receptacle module 100 having an array of receptacle contacts 102 configured to be mateable and unmateable from a plug module 200 having a mating array of plug contacts 202. The plug module 200 includes a safety mechanism 300 that is configured for movement between the unmated position and a mated position (FIG. 9), which is described in more detail below. In the unmated position, the safety mechanism 300 shrouds and/or isolates the plug contacts 202 from electrical contact from any conductive objects, including but not limited to the receptacle contacts 102, tools (not shown), electrical devices (not shown), personnel (not shown), and the like. In the mated position, the safety mechanism 300 allows or provides for mating between the receptacle contacts 102 and plug contacts 202.

The electrical connector assembly 10 includes a main power circuit 12 having a power supply 14 and a load 16, such as an electrical device electrically connected by the modules 100, 200, receptacle cables 104, and plug cables 204. In an exemplary embodiment, the main power circuit 12 is a high-power circuit, such as a three phase 100 Amp, 416 Volt, electrical power circuit. However, the main power circuit 12 may be used with any configuration, including a higher or lower voltage, a higher or lower amperage, and/or a single phase. The main power circuit 12 may be used in any suitable application, including, but not limited to, data storage applications, to computers, power systems, servers, networks and the like. FIG. 1 depicts the power supply 14 and load 16 connected to respective modules 100 and 200. Alternatively, the power supply 14 and the load 16 and may be switched to connect to respective modules 200 and 100.

As shown, each cable 104, 204 include a plurality of wires 106, 206 surrounded by an external jacket 108, 208 to form the larger cable 104, 204. The external jacket 108, 208 may be stripped to permit manipulation of the wires 106, 206 as set forth herein. The wires 106, 206 are configured to electrically couple with respective receptacle contacts 102 and plug contacts 202. For example, each of the wires 106, 206 may have a single central conductor surrounded by an external jacket or sleeve. In alternative embodiments, the wires 106, 206 may form a twisted pair of signal conductors rather than the single central conductor. In the exemplary embodiment, the cables 104, 204 each include five (5) wires 106, 206. However, the cables 104, 204 may include any number of wires, including one.

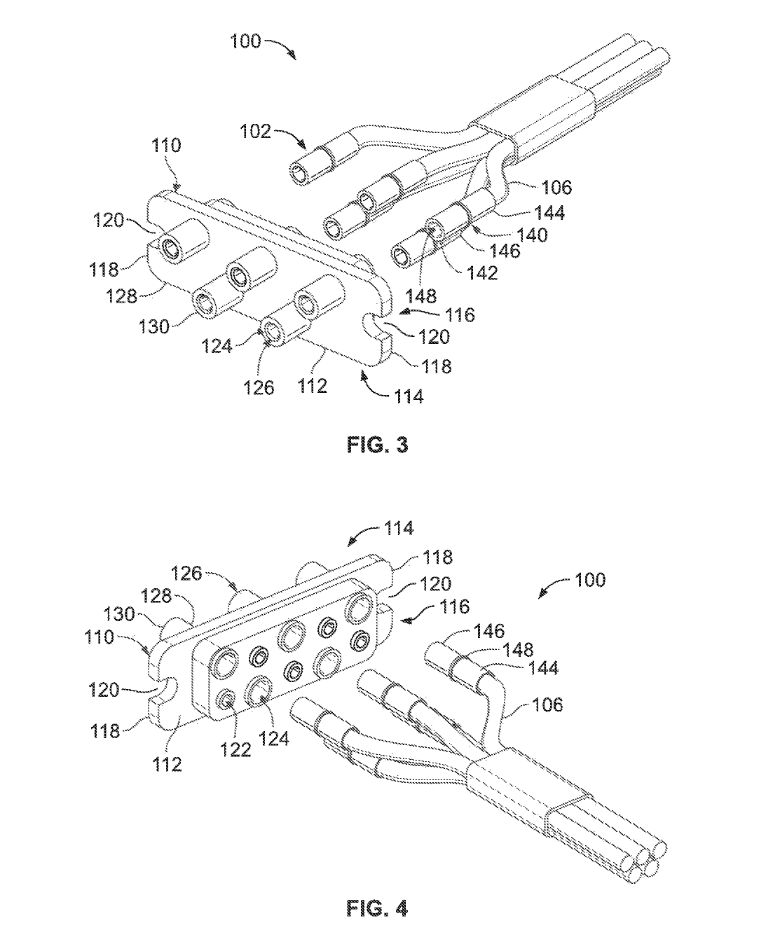

FIG. 3 is a front partially exploded perspective view of a receptacle module 100 in accordance with an embodiment. FIG. 4 is a rear partially exploded perspective view of the receptacle module 100 in accordance with an embodiment. The receptacle module 100 includes a receptacle carrier 110 having a generally rectangular planar body 112 with a receptacle mating end 114 and a receptacle cable end 116 opposite the receptacle mating end 114. As illustrated, the receptacle module 100 is configured to be mounted to a support structure (not shown), such as, a panel, a backplane, chassis, bulkhead, rack and panel assembly, or the like. For example, opposing ends 118 of the body 112 include semi-circular detents 120 configured for receipt of fasteners (not shown) to mount the receptacle module 100 to the support structure (not shown). Optionally, the body 112 may include threaded bores 122 for receipt of fasteners to mount the receptacle module 100 to the support structure.

A plurality of receptacle channels 124 extends through the receptacle module 100 from the receptacle mating end 114 to the receptacle cable end 116 along a central longitudinal axis of each channel 124. The receptacle channels 124 are configured to receive the receptacle contacts 102. A plurality of extension members 126 extend from the receptacle mating end 114 and form extended portions of the receptacle channels 124 in alignment with the array of receptacle channels 124 along the central longitudinal axis’. In the exemplary embodiment, each extension member 126 is generally cylindrical having a proximal end 128 proximate to the receptacle mating end 114 and a distal end 130 opposite the proximal end 128. The extension members 126 are configured to engage with the safety mechanism 300 (FIG. 1) for movement between the unmated position and the mated position. In an exemplary embodiment, the receptacle contacts 102 are recessed within the channel 124 at a distance from the distal end 130 of the extension member 126 to shroud or isolate the receptacle contact 102 from electrical contact with conductive objects, including, but not limited to the plug contacts 202, tools (not shown), electrical devices (not shown), personnel (not shown), and the like.

In the illustrated embodiment, the receptacle module 100 includes five (5) receptacle contacts 102 arranged in a pattern having a first row of two receptacle contacts 102 and second row of three (3) receptacle contacts 102 forming triangular groups with generally equal spacing between the receptacle contacts 102. In other various embodiments, the receptacle module 100 may include any number of receptacle contacts 102 arranged in any pattern having any number of rows, any type of spacing, and/or any type of grouping.

In an exemplary embodiment, each receptacle contact 102 includes a terminal body 140 configured for electrically connecting a socket terminal 142 with the corresponding wire 106. For example, the terminal body 140 may be a cylindrical member having a wire end 144 a socket end 146, defining a respective cavity 148. The wire end 144 is configured for electrically and mechanical connecting or terminating with the corresponding wire 106. For example, the wire end 144 may be configured for holding the wire 106 with an interference fit. Alternatively, the wire end 144 may connect with the wire 106 using any other connection, such as crimping, soldering conductive adhesive, fastening, and the like. Additionally, the socket end 146 may be configured for holding the socket terminal 142 with an interference fit. Alternatively, the socket end 146 may connect with the socket terminal 142 using any other connection, such as, soldering, conductive adhesive, and the like.

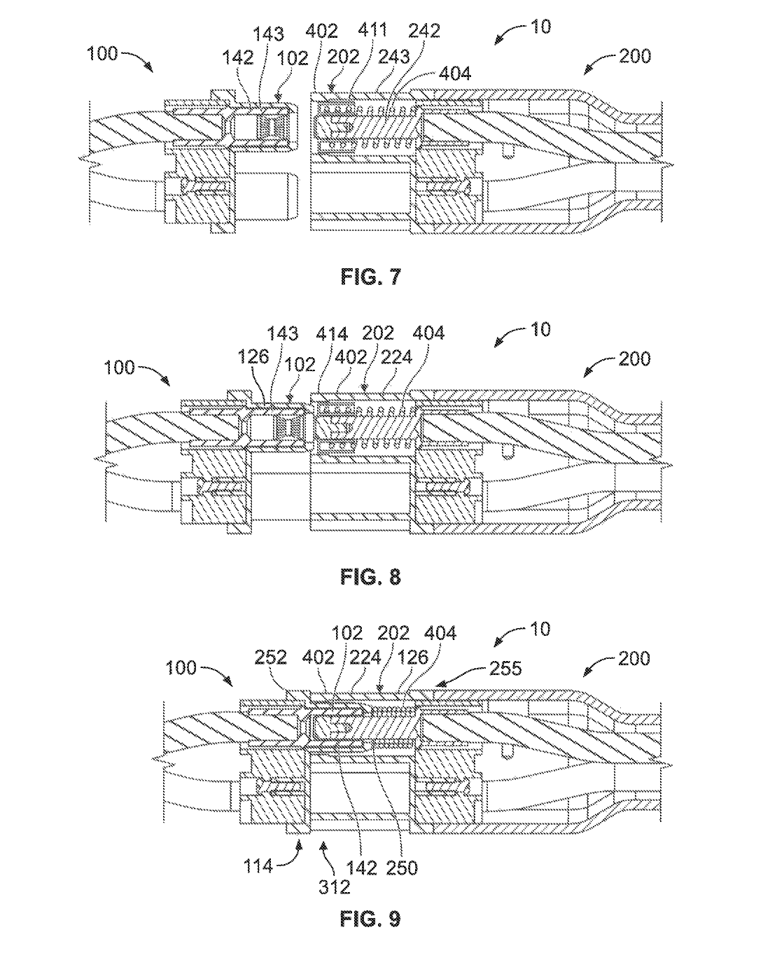

In an exemplary embodiment, the socket terminal 142 is a female crimp-type contact configured to mate and unmate with the plug contact 202. For example, the socket terminal 142 may include a cylindrical conductive band 143 (FIG. 7) that forms a cavity configured to receive the plug contact 202. As discussed below in more detail, in the mated position an inner surface 145 of the conductive band 143 may electrically contact the plug contact 202 with an interference fit. In alternate embodiments, the socket terminal 142 may include any configuration that provides for electrical mating and unmating between with the plug contact 202. For example, the socket terminal 142 may include a female receptacle for a post, jack, plug, blade terminal, spade terminal, fork terminal, contact, and the like.

The receptacle carrier 110 may be formed of a dielectric material, such as plastic or one or more other polymers. Optionally, the receptacle carrier 110 may be overmolded or injection molded around the receptacle contacts 102. Alternatively, the receptacle contacts 102 may be loaded or stitched into a pre-formed dielectric carrier 110.

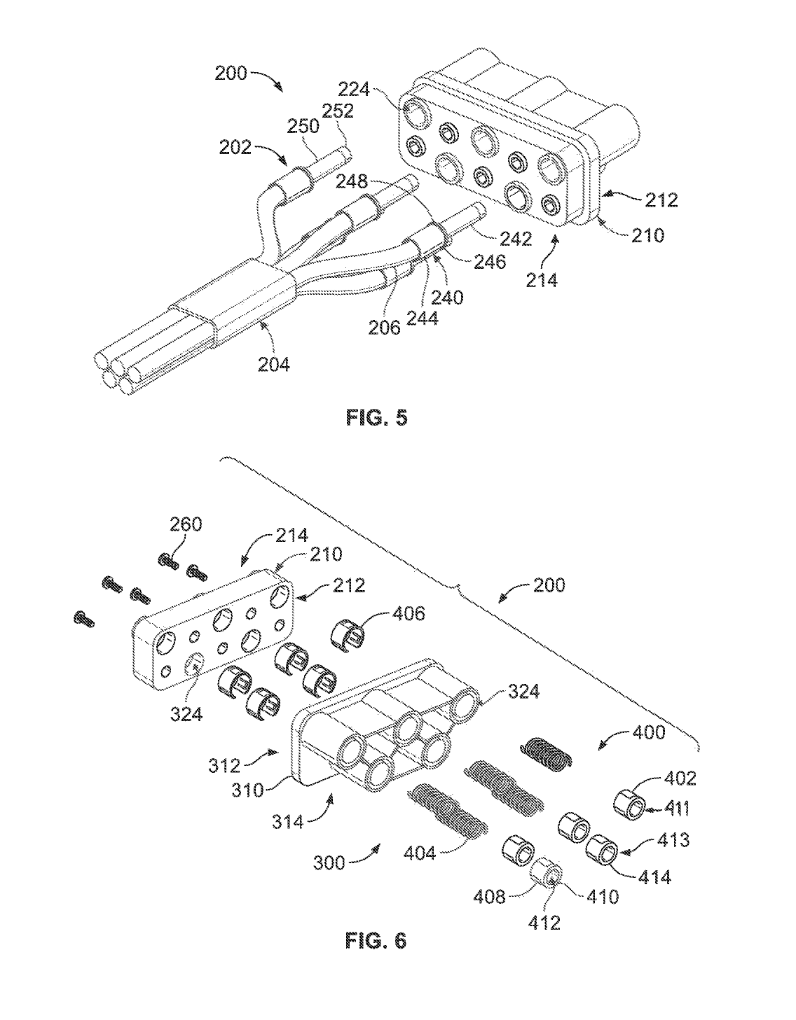

FIG. 5 is a rear partially exploded perspective view of the plug module 200 and a safety mechanism 300 in accordance with an embodiment. The plug module 200 includes a plug carrier 210 having a plug mating end 212 and a plug cable end 214 opposite the plug mating end 212. Optionally, the plug module 200 may be configured to be mounted to a support structure. A plurality of plug channels 224 extends through the plug module 200 from the plug mating end 212 to the plug cable end 214 along a central longitudinal axis of each channel 224. The plug channels 224 are configured to receive the plug contacts 202.

In the illustrated embodiment, the plug module 200 includes five (5) plug contacts 202 arranged in a pattern having a first row of two plug contacts 202 and second row of three (3) plug contacts 202 forming triangular groups with generally equal spacing between the plug contacts 202. In other various embodiments, the receptacle module 100 may include any number of plug contacts 202 arranged in any pattern having any number of rows, any type of spacing, and/or any type of grouping.

In an exemplary embodiment, each plug contact 202 includes a terminal body 240 configured for electrically connecting the wire 206 with a plug terminal 242. For example, the terminal body 240 may be a cylindrical member having a wire end 244 and a plug end 246, and defining respective cavities 248. The wire end 244 is configured for electrically and mechanical connecting or terminating with the respective wire 206. For example, the wire end 244 may configured for holding the wire 206 with an interference fit. Alternatively, the wire end 244 may connect with the wire 206 using any other connection, such as crimping, soldering, conductive adhesive, fastening, and the like. The plug terminal 242 is a male pin-type terminal configured to mate and unmate with the socket terminal 142 of the receptacle contact 102. For example, the plug terminal 242 may include a conductive outer surface 250 terminating at a distal end with an insulative tip 252 configured for pluggable insertion with the socket terminal 142 of the receptacle contact 102. As discussed below in more detail, in the mated position an outer surface 250 of the plug terminal 242 may electrically contact the inner surface 145 of the socket terminal 142 with an interference fit. In alternate embodiments, the plug terminal 242 may include any configuration that provide for electrical mating and unmating with the receptacle contact 102. For example, the plug terminal 242 may include a post, jack, plug, blade terminal, spade terminal, fork terminal, contact, and the like.

The plug carrier 210 may be formed of a dielectric material, such as plastic or one or more other polymers. For example, the plug carrier 210 may include an overmolded body molded around at least a portion of the plug end 246 of the terminal body 240 at least a portion of the wire end 244 extending outwardly from the plug channel 224 along the central longitudinal axis. Alternatively, the plug contacts 202 may be loaded or stitched into a pre-formed dielectric plug carrier 210.

FIG. 6 is an exploded perspective view of the plug module 200 in accordance with an embodiment. The safety mechanism 300 includes a body 310 having a safety mating end 312 and an engagement end 314 opposite the safety mating end 312. The safety mating end 312 is configured for mating with the plug mating end 212 of the plug carrier 210. For example, the body 310 may attach to the plug carrier 210 with fasteners 260, however, adhesive, tape, latches, and the like may also be used. Optionally, the plug carrier 210 and the body 310 may be formed as a unitary member. The engagement end 314 is configured to engage with the receptacle mating end 114 of the receptacle module 100 (FIG. 1). A plurality of cavities 324 extends through the body 310 from the safety mating end 312 to the engagement end 314 along a central longitudinal axis of each cavity 324. The cavities 324 are arranged in a pattern corresponding and aligned with the pattern of the plug channels 224 to form extended portions of the plug channels 224. Each cavity 324 is configured to receive a plunger assembly 400. In addition, a retaining member 406 resides within each cavity 324. Each retaining member 406 is configured to couple with a corresponding plug contact 202 to secure the plug contacts 202 to the plug module 200.

In the illustrated embodiment, the safety mechanism 300 includes five (5) plunger assemblies 400 arranged in a pattern corresponding to the pattern of plug contacts 202. For example, the plunger assemblies 400 may be arranged in a pattern having a first row of two plunger assemblies 400 and second row of three (3) plunger assemblies 400 forming triangular groups with generally equal spacing between the plunger assemblies 400. In other various embodiments, the safety mechanism 300 may include any number of plunger assemblies 400 arranged in any pattern having any number of rows, any type of spacing, and/or any type of grouping.

As shown in FIG. 6, each plunger assembly 400 includes an insulative plunger 402 configured for movement along the central longitudinal axis of the cavity 324 and/or plug channel 224 between an unmated position and a mated position. The insulative plunger 402 is operatively connected to a plunger spring 404 configured to bias the insulative plunger 402 in the direction of the unmated position. For example, the plunger spring 404 may be a compression spring received in the cavity 324 and/or plug channel 224. The plunger spring 404 and the insulative plunger 402 may be received in the cavity 324 by insertion into the cavity 324 at the engagement end 314 of the body 310. The plunger spring 404 and the insulative plunger 402 may be retained within the cavity 324 by a tab (not shown) or other suitable retaining element. In addition, the tab may limit the travel of the plunger spring 404 and the insulative plunger 402 so that the plunger spring 404 does not eject the insulative plunger 402 from the cavity 324. Alternatively, the spring 404 can be replaced with any other biasing element, such as, a rubber, foam, and/or elastic member.

In the exemplary embodiment, the insulative plunger 402 is generally barrel-shaped having an outer surface 408 and an inner surface 410 forming a bore 412. The outer surface 408 is configured to be moveably received within the cavity 324 and/or plug channel 224, such as with a clearance fit. The bore 412 is configured to receive the plug terminal 242 of the plug contact 202 so that the insulative plunger 402 moves along the central longitudinal axis between the unmated and mated positions. A proximal end 411 of the insulative plunger 402 is configured to contact the plunger spring 404 so that the spring may bias the insulative plunger 402 in the direction of the unmated position. A distal end 413 of the insulative plunger 402 includes an interface 414 configured to engage the extension members 126 (FIG. 3) of the receptacle module 102. The insulative plunger 402 may be formed of a dielectric material, such as plastic, ceramic or one or more other insulative materials.

FIG. 7 is a cross-sectional view of the electrical connector assembly 10 with the receptacle module 100 and the plug module 200 in the unmated position according to an embodiment. When the electrical connector assembly 10 is in the unmated position the plug module 200 and plug contacts 202 are electrically disconnected from the receptacle module 100 and receptacle contacts 102. The spring 404 biases the insulative plunger 402 proximate to a distal end 243 of the plug terminal 242. For example, the insulative plunger 402 may be positioned to surround the insulative tip 252 of the plug terminal so that the conductive outer surface 250 of the plug terminal 242 is isolated within the plug channel 224 from electrical contact with any conductive objects. The socket terminals 142 of the receptacle contacts 102 are recessed within the receptacle channels 124 of the receptacle carrier 110 to isolate the socket terminals 142 from electrical contact with any conductive objects too large to fit in the opening 124. In the unmated position, the receptacle module 100 is protected from incidental or accidental contact with human fingers or conductive objects larger than the receptacle contact openings 124. The plug module 200 is unable to make incidental or accidental electrical contact with any conductive objects and therefore may be handled by untrained personnel.

FIG. 8 is a cross-sectional view of the electrical connector assembly 10 with the receptacle module 100 and the plug module 200 in an impending mating position according to an embodiment. When the electrical connector assembly 10 is in the impending mating position, the extension members 126 initially insert into the plug channels 224 and contact the insulative plunger 402 at interfaces 414. Similar to the unmated position (FIG. 7), the receptacle module 100 and plug module 200 are unable to make incidental or accidental electrical contact with conductive objects and therefore may be handled by untrained personnel.

FIG. 9 is a cross-sectional view of the electrical connector assembly 10 with the receptacle module 100 and the plug module 200 in the mated position according to an embodiment. When the electrical connector assembly 10 is in the mated position the plug module 200 and plug contacts 202 are electrically connected with the receptacle module 100 and receptacle contacts 102. The extension members 126 insert further into the plug channels 224 compressing the spring 404 and moving the insulative plunger 402 proximate the proximal end 255 of the plug terminal 242. The receptacle mating end 114 mates with the safety mating end 312 of the safety assembly 300. The socket terminal 142 moves past the insulative tip 252 and electrically contacts the conductive outer surface 250 of the plug terminal 242. In the mated position, electrical power is communicated from the power supply 14 to the load 16 via mated receptacle and plug modules 100, 200 and cables 104, 202.

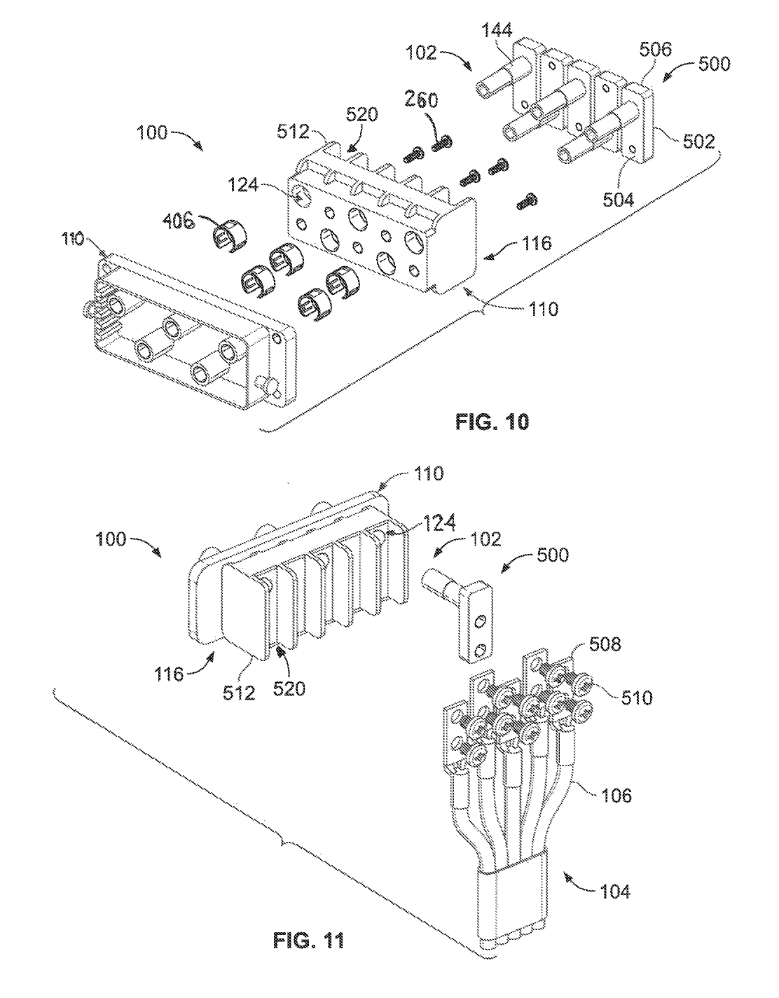

FIG. 10 is a front exploded perspective view of the receptacle module 100 with adaptors 500 according to an embodiment. FIG. 11 is a rear partially exploded view of the receptacle module 100 with the adaptors 500 and cable 104 according to an embodiment. Each adaptor 500 is configured to electrically connect the wires 106 of the cable 104 to the receptacle contacts 102 in a non-parallel position relative to the central longitudinal axis of the receptacle channels 124. In the exemplary embodiment, each adaptor 500 includes a generally rectangular body 502 having a carrier surface 504 and an opposite terminal surface 506. The carrier surface 504 is configured to electrically connect to the receptacle contact 102. For example, the wire end 144 of the terminal body 140 may attach to the carrier surface 504, such as by welding, adhesive, and the like. The terminal surface 506 is configured to electrically connect to the wire 106 with a terminal 508, such as a crimp connector using fasteners 510. However, the wire 106 can attach to the terminal surface 506 using any type of mechanical connection, including, but not limited to, welding, soldering, conductive adhesive, and the like. Optionally, the receptacle carrier 110 may include guides 512 extending from the cable end 116 that form channels 520 therebetween. The channels 520 are configured to receive the adapters 500. The adaptors 500 are secured to the receptacle carrier 110 with retaining rings, fasteners, conductive adhesive, and the like. The adaptors 500 may be made from a conductive material, including, but not limited to stainless steel, copper, aluminum, alloys, composite conductive materials, and the like. In various embodiments, the adaptors may be stamped, forged, molded, or otherwise formed.

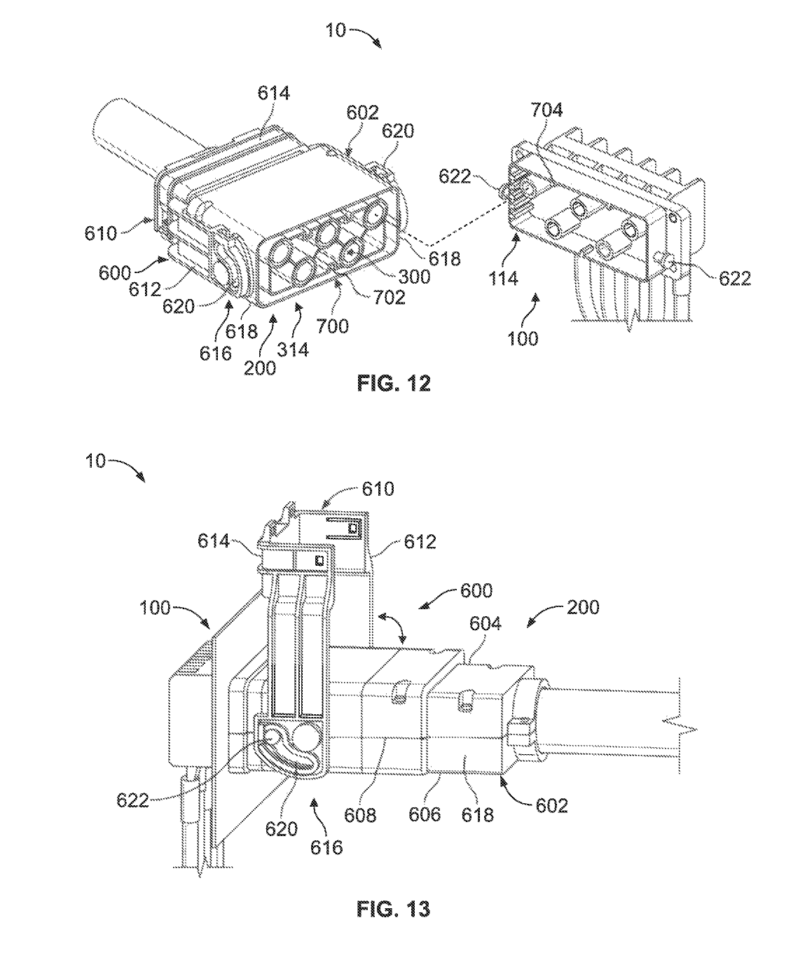

FIG. 12 is a perspective view of the electrical connector assembly 10 in the unmated position with a latch assembly 600 in a secured position and keying features 700. FIG. 13 is a side view of the electrical connector assembly 10 in the mated position with the latch assembly 600 in the unsecured position according to an embodiment. The latch assembly 600 is configured to secure the receptacle module 100 and the plug module 200 and retain the relative positioning and orientation relative to each other. In the illustrated embodiment, the latch assembly 600 includes a plug module housing 602 that generally surrounds the plug carrier (not shown) and the safety mechanism 300. For example, the plug module housing 602 may include an upper shell 604 and a lower shell 606 configured to mate along an interface 608 along the length of the shells 604, 606 and forming a cavity therebetween that extends the length of the shells 604, 606 which is configured to hold at least a portion of the plug carrier 210 and the safety mechanism 300. The latch assembly 600 also includes a lever arm 610 configured to movably attach to the plug module housing 602 for movement between the secured position (FIG. 12) and the unsecured position (FIG. 13). For example, the lever arm 610 may include two arms 612 with a crossmember 614 extending therebetween. Each arm 612 includes a distal end 616 pivotally attached to opposing sidewalls 618 of the plug module housing 602. Each arm 612 includes an arcuate slot 620 configured to receive a corresponding tab 622 provided on the receptacle carrier 110 in the unsecured position and couple with the tab 622 in the secured position. However, the lever arm 612 can include any configuration that provides for securing and unsecuring the receptacle module 100 and the plug module 200. Optionally, other types of securing features may be used to secure the receptacle module 100 and the plug module 200, such as a tab, a latch, a retaining member, a mechanical interference fit, fasteners, bonding, adhesive, and the like.

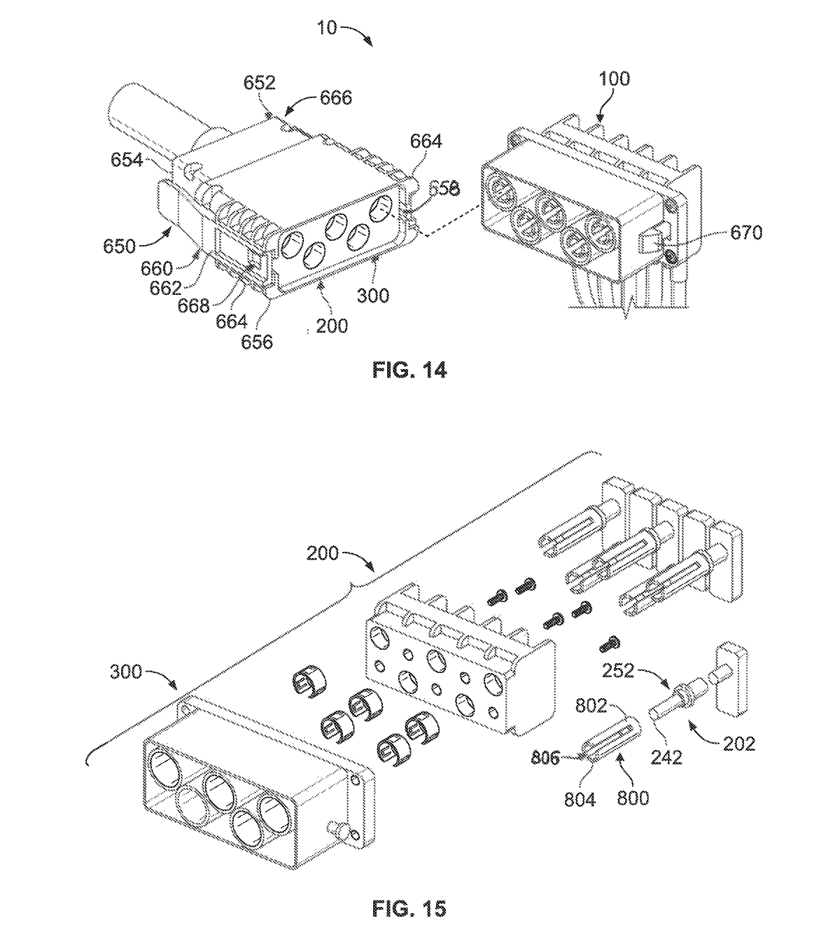

FIG. 14 is a perspective view of the electrical connector 10 assembly with an alternate latch assembly 650 according to an embodiment. The latch assembly 650 is configured to secure the receptacle module 100 and the plug module 200 and retain the relative positioning and orientation relative to each other. In the illustrated embodiment, the latch assembly 650 includes a plug module housing 652 that generally surrounds the plug carrier 210 and the safety mechanism 300. For example, the plug module housing 652 may include an upper shell 654 and a lower shell 656 configured to mate along an interface 658 along the length of the shells 654, 656. The upper and lower shells 654, 656 form a cavity therebetween that extends the length of the shells 654, 656. The cavity is configured to hold at least a portion of the plug carrier (not shown) and the safety mechanism 300. The latch assembly 650 also includes a lever arm 660 configured to movably attach to the plug module housing 652 for movement between the secured position and the unsecured position. For example, the lever arm 660 may include two arms 662 attached to opposing sidewalls 664 of the plug module housing 652 at the cable end 666 and provide that the opposite ends of the arms 662 bend or pivot between a secured and unsecured position. Each arm 662 includes a slot 668 configured to engage a corresponding tab 670 provided on the receptacle carrier 110 in the secured position and disengage the tab 670 in the unsecured position. For example, as the receptacle module 100 and plug module 200 are coupled, a sloped face of the tab 670 pivots the lever arm 660 outwardly relative to the plug module housing 652 to the unsecured position to allow the tab 670 to be received in the slot 668. The lever arm 660 pivots inwardly relative to the plug module housing 652 to the secured position to secure the tab 670 within the slot 670, which prevents relative movement between the receptacle module 100 and the plug module 200.

Referring back to FIG. 12, the electrical connector assembly 10 may include keying features 700 configured to provide that the receptacle module 100 and the plug module 200 mate in a predetermined orientation. For example, the plug module 200 may include a key pattern 702 proximate the engagement end 314. The receptacle module 100 may include a mating key pattern 704 proximate the receptacle mating end 114. The mating key pattern 704 is configured to mate and unmate with the key pattern 702 so that the plug module 200 and receptacle module 100 mate in a predetermined orientation. Other types of keying features may be used in alternative embodiments, such as slots, keys, or other types of keying features.

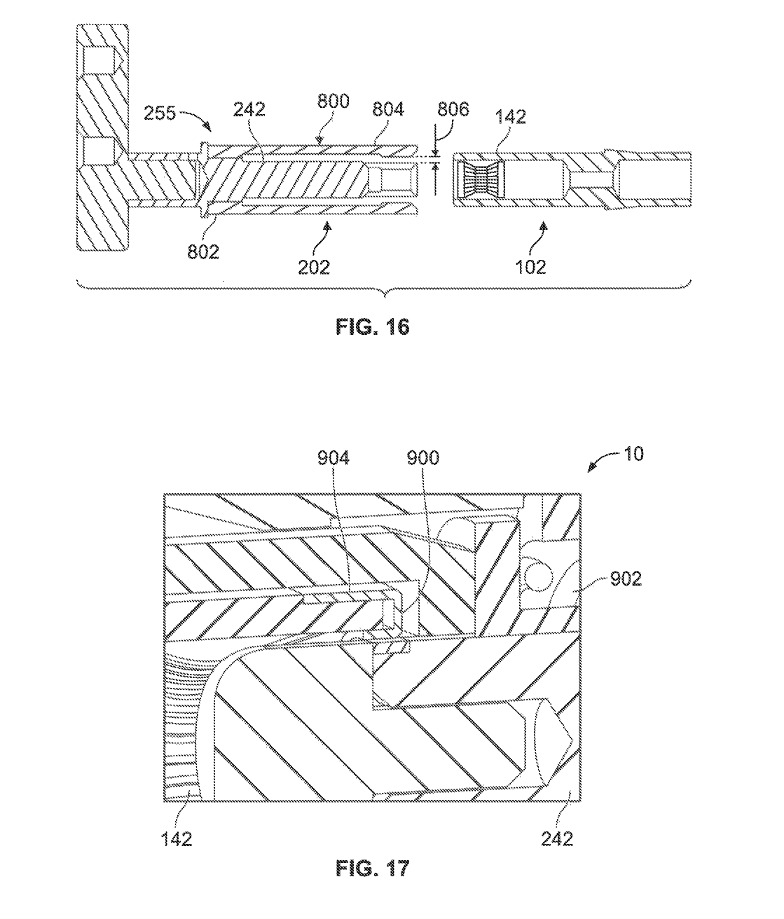

FIG. 15 is a partially exploded perspective view of the plug module 200 with a pre-mate connector 800 according to an embodiment. FIG. 16 is a cross-section view of the electrical assembly 10 with the pre-mate connector 800 in the unmated position. As illustrated in the exemplary embodiment, the pre-mate connector 800 replaces the plunger assembly 400 of the safety mechanism 300 to shroud and/or isolates the plug contacts 202 from electrical contact from any conductive objects, including but not limited to the receptacle contacts 102, tools (not shown), electrical devices (not shown), personnel (not shown), and the like. The pro-mate connector 800 is configured to surround the plug terminal 242 to mate first and unmate last with the outer surface of the receptacle contact 102. The pre-mate connector is also configured to protect the plug terminal 242 from damage due to arcing when the plug contacts 202 and the receptacle contacts 102 are mating. For example, the pre-mate connector 800 includes a cylindrical base 802 that attaches to the proximal end 255 of the plug terminal, and fingers 804 that extend parallel with the outer surface 250 of the plug terminal 242 defining a gap 806 therebetween that is configured to receive the socket terminal 142. Mating and unmating of the plug terminal 242 and socket terminal 142 occurs as previously described above. As shown in FIG. 15, the pre-mate connector 800 includes four (4) fingers, however, the pre-mate connector may include any number of fingers 804.

FIG. 17 is an enlarged cross-section view of sacrificial contacts 900 of the pre-mate connector 800 in the mating position. Optionally, the electrical connector assembly 10 may include sacrificial members 900 attached to the receptacle contacts 102 and plug contacts 202 to initiate electrical contact during the mating position. For example, the plug contact 202 may include a plug sacrificial contact 902 proximate the distal end 243 of plug terminal 242, the receptacle contact 102 may include a mating receptacle sacrificial contact 904 proximate a distal end of the socket terminal 142. The initial electrical contact of the sacrificial contacts 900 prevents damage to the plug terminal 242 and socket terminal 142 due to spark formation during mating and unmating in an energized condition.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. An electrical power connector assembly, comprising:
a plug module having a plug carrier with a plug mating end, a plug cable end opposite the plug mating end, and a plug channel extending therebetween, a plug contact received within the plug channel, and a plug cable electrically connected to the plug contact;
a receptacle module having a receptacle carrier with a receptacle mating end, a receptacle cable end opposite the receptacle mating end, and a receptacle channel extending therebetween, the receptacle contact received within the receptacle channel and being matable with and unmatable with the plug contact, and a receptacle cable electrically connected to the receptacle contact proximate the receptacle cable end; and
a safety mechanism received within the plug channel and configured to move within the plug channel between an unmated position wherein the plug contact is isolated from electrical contact from a conductive object and a mated position that provides for mating between the plug contact and the receptacle contact.

2. The electrical power connector assembly of claim 1, wherein the safety mechanism includes a body with a safety mating end configured for mating with the plug mating end, an engagement end opposite the safety mating end and a cavity extending therebetween and aligned with the plug channel to form an extended portion of the plug channel, and an insulative plunger configured to move along a central longitudinal axis of the plug contact within the plug channel between the unmated position and the mated position.

3. The electrical power connector assembly of claim 2, further comprising a plunger spring received within the plug channel and configured to bias the insulative plunger to the unmated position.

4. The electrical power connector assembly of claim 1, wherein the receptacle contact is recessed within the receptacle channel to isolate the receptacle contact from electrical contact with the conductive object.

5. The electrical power connector assembly of claim 1, further comprising:
a tab provided on the receptacle carrier;
a plug module housing having an upper shell and a lower shell mating along an interface along the length of the shells, the upper and lower shells forming a cavity therebetween that extends the length of the shells, the cavity configured to hold at least a portion of the plug module; and
a lever arm moveably attached to the plug module housing and configured for coupling with the tab of the receptacle housing in a secured position and an uncoupling with the tab of the receptacle in an unsecured position.

6. The electrical power connector assembly of claim 1, wherein the plug contact includes a terminal end, a distal end opposite the terminal end and a conductive surface extending therebetween, and an electrically insulative tip at the distal end.

7. The electrical power connector assembly of claim 1, wherein the receptacle module includes an extension member extending from the mating face, the extension member configured to form the receptacle channel for receipt of the receptacle contact, the extension member having a proximal end proximate the receptacle mating end and a distal end opposite the proximal end being configured to engage the safety mechanism for movement to the mated position.

8. The electrical power connector assembly of claim 1, wherein the receptacle module includes an adaptor received in the receptacle channel and having a terminal surface;
wherein the receptacle cable includes a terminal configured for electrical and mechanical coupling with the terminal surface of the adaptor at a non-parallel position relative to a central longitudinal axis of the receptacle channel.

9. The electrical power connector assembly of claim 1, further comprising a plug sacrificial contact proximate a distal end of the plug contact and a receptacle sacrificial contact electrically isolated from the cable proximate a distal end of the receptacle contact, the sacrificial contacts electrically isolated from the cable being configured to make initial electrical contact between the plug contact and the receptacle contact in a pre-mating position.

10. The electrical power connector assembly of claim 1, further comprising a pre-mate connector configured to shroud the plug contact from electrical contact with the conductive object.

11. An electrical power connector assembly, comprising:
a receptacle module having a receptacle carrier with a receptacle mating end, a receptacle cable end and at least one receptacle channel extending therebetween, at least one receptacle contact received within the at least one receptacle channel, and at least one receptacle cable electrically connected to the at least one receptacle contact proximate the receptacle cable end;
a plug module having a plug carrier with a plug mating end, a plug cable end opposite the plug mating end, and a plug channel extending therebetween, at least one plug contact received within the at least one plug channel and having a conductive surface extending along a central longitudinal axis being configured to mate and unmate with the at least one receptacle contact, and at least one plug cable electrically connected to the at least one plug contact, at least one insulative plunger configured to move along the central longitudinal axis of the plug contact between an unmated position wherein the conductive surface is isolated from electrical contact with one or more conductive objects and a mated position that provides for mating between the conductive surface of the plug contact and the receptacle contact.

12. The electrical power connector assembly of claim 11, wherein the safety mechanism includes a body with a safety mating end configured for mating with the plug mating end, an engagement end opposite the safety mating end and one or more cavities extending therebetween and aligning with the one or more plug channels to form one or more extended portions of the one or more plug channels, and one or more insulative plungers configured to move along a central longitudinal axis of the plug contacts within the one or more plug channels between the unmated position and the mated position.

13. The electrical power connector assembly of claim 11, further comprising at least one plunger spring received within the at least one plug channel and configured to bias the at least one insulative plunger to the unmated position.

14. The electrical power connector assembly of claim 11, wherein the one or more receptacle contacts are recessed within the one or more receptacle channels to isolate the receptacle contact from electrical contact with one or more conductive objects.

15. The electrical power connector assembly of claim 11, further comprising:
at least one tab provided on the receptacle carrier;
a plug module housing having an upper shell and a lower shell mating along an interface along the length of the shells, the upper and lower shells forming a cavity therebetween that extends the length of the shells, the cavity configured to hold at least a portion of the plug module; and
a lever arm moveably attached to the plug module housing and configured for coupling with the at least one tab of the receptacle housing in a secured position and uncoupling with the tab of the receptacle in an unsecured position.

16. The electrical power connector assembly of claim 11, wherein the plug contact includes a terminal end, a distal end opposite the terminal end and a conductive surface extending therebetween, and an electrically insulative tip at the distal end.

17. The electrical power connector assembly of claim 11, wherein the receptacle module includes at least one adaptor received in the at least one receptacle channel and having a terminal surface;
wherein the at least one receptacle cable includes a terminal configured for electrical and mechanical coupling with the terminal surface of the at least one adaptor at a non-parallel position relative to a central longitudinal axis of the at least one receptacle channel.

18. The electrical power connector assembly of claim 11, further comprising a plug sacrificial contact proximate a distal end of the at least one plug contact and a receptacle sacrificial contact proximate a distal end of the at least one receptacle contact, the sacrificial contacts being configured to make initial electrical contact between the at least one plug contact and the at least one receptacle contact in a pre-mating position.

19. The electrical power connector assembly of claim 11, further comprising a pre-mate connector configured to shroud the plug contact from electrical contact with one or more conductive objects.

20. An electrical power connector, comprising:
a plug module configured for mating and unmating with a receptacle module, the plug module having a plug carrier with a plug mating end, a plug cable end, and a plug channel extending therebetween, at least one plug contact received within the at least one plug channel and having a conductive surface extending along a central longitudinal axis being configured to mate and unmate with the receptacle module, and at least one plug cable electrically connected to the at least one plug contact, at least one insulative plunger configured to move along the central longitudinal axis of the plug contact between an unmated position wherein the conductive surface is isolated from electrical contact with the receptacle module and a mated position that provides for mating between the conductive surface of the plug contact and the receptacle module.
